(19) United States
(12) Patent Application Publication
(10) Pub. No.: US 2014/0196328 A1
(43) Pub. Date: Jul. 17, 2014

(54) Edge lit sign incorporating a mirror

(71) Applicant: Mark Swartz, Charlotte, NC (US)

(72) Inventor: Mark Swartz, Charlotte, NC (US)

(21) Appl. No.: 14/181,704

(22) Filed: Feb. 16, 2014

(51) Int. Cl. G09F 13/18; F21V 8/00

(52) U.S. Cl. CPC G09F 13/18; G02B 6/006
USPC 40/546

(57) ABSTRACT

A very thin edge lit sign is described using a mirrored acrylic sheet or similar material. The mirrored side is engraved to create an Image and the reverse side is painted any color desired to provide illumination in the engraved areas. A bright white LED light strip is enclosed in a piece of trim attached to the top and bottom of the sign. The resulting sign can have vivid multicolor illumination and is thin enough to be magnet mounted to the side of a vehicle.

### BACKGROUND OF THE INVENTION

The original intent of this invention was to create a very thin, bright, durable, edge lit sign which could easily be attached to the side of a motor vehicle with magnets or other means. Edge lit signs traditionally function by trapping light inside of a highly polished or otherwise smooth piece of light transmitting material, and having certain areas engraved to reflect the light out, thereby creating an image. Prior edge lit signs use a light transmitting sheet of material with no protection from the elements. This is not suitable for outdoor used because dust, dirt and scratches will quickly degrade the sign causing light to be reflected out in undesired areas. This is a significant problem for edge lit signs used outdoors, especially considering their generally poor contrast ratio between illuminated and non illuminated areas. Painting or coating the entire front surface of the sign, except in designated areas to create an illuminated image, is an inefficient solution because the paint or coating tends to absorb light or reflect it out of the light transmitting material comprising the sign resulting in a substantial loss of efficiency.

Prior edge lit sign designs abound, but none of them use an inverted mirror to solve the problem of fingerprints, dirt, or scratches in the light transmitting sheet causing illumination in undesired areas. Other flat signs have used sheets of electroluminescent material in an effort to overcome this problem, however electroluminescent sheets are easily destroyed by punctures, shorter lived and not as bright as compared to light emitting diodes.

### BRIEF SUMMARY OF THE INVENTION

This invention uses a sheet of mirrored light transmitting material to solve the problem of prior edge lit sign designs: dirt, fingerprints, and minor scratches will cause light to be reflected out of the light transmitting material comprising the sign in undesired areas. This invention also provides a superior contrast ratio to prior edgelit signs. In addition to covering the non-illuminated front sides of the sheet, the areas on the back of the sheet directly opposite the illuminated areas seen from the front are painted. This significantly improves brightness of the illuminated areas as seen from the front. The combination of a mirror front and painted back make this edgelit sign design novel and truly unique. The finished product resembles a traditional vinyl lettered sign board, except the letters and selected other features light up. The entire completed sign assembly is generally under ¼″ thick.

### DESCRIPTION OF THE DRAWINGS

FIG. 1: Front view of the sign

FIG. 2: side view of the sign showing edge trim orientation

FIG. 3: enlarged edge view showing light blocking trim and SMD LED detail

FIG. 4: Enlarged cross section at an engraved, illuminated area of the sign

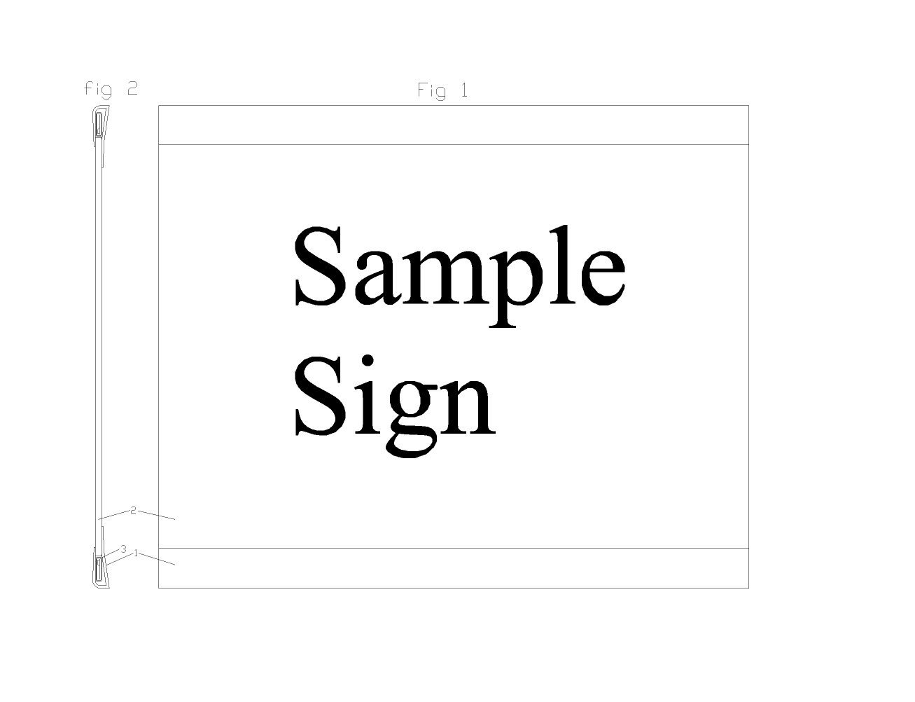

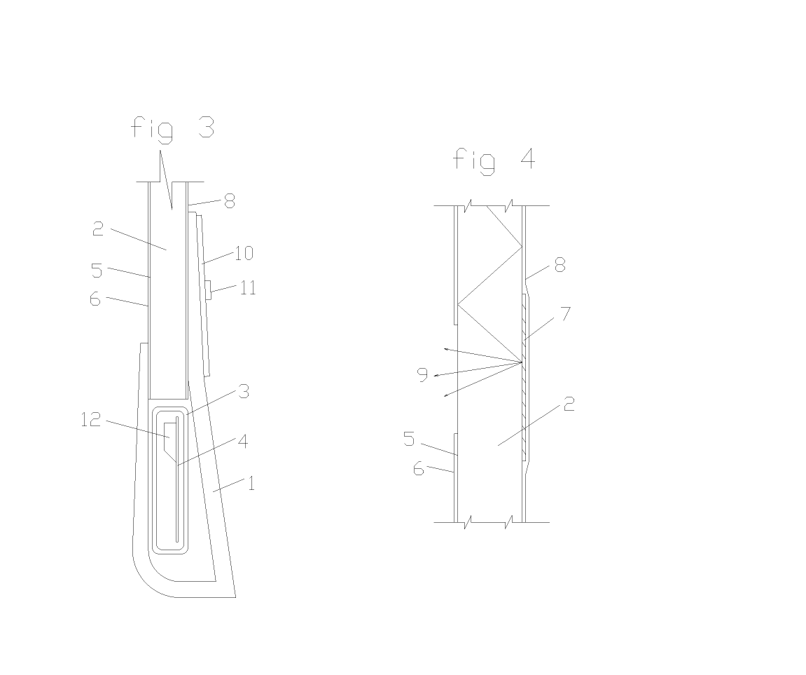

1. Light blocking trim, light from the SMD LED strip is only allowed into the edge of the light transmitting sheet.

2. Light transmitting sheet of material, typically acrylic or polycarbonate

3. Transparent plastic tube housing the SMD LED light strip. Typically PVC or silicone rubber

4. Ribbon circuit board holding SMD LED's

5. Silver mirror coating or silver mirrored vinyl or mylar film

6. Vinyl film or paint of any color

7. Exterior acrylic or latex paint, brightly colored or white

8. Silver mirrored mylar or vinyl film

9. Light is contained within the sign until it hits the paint on the back of the sign and is reflected out of the sign toward the viewer.

10. Galvanized steel plate glued to the light blocking trim with flexible waterproof glue

11. Neodymium magnet

12. SMD LED. Typically bright white

### DETAILED DESCRIPTION OF THE INVENTION

This invention consists of a edge lit sign consisting of a sheet of light transmitting material, preferably polycarbonate or acrylic in which the side facing the viewer has a silver mirrored coating, which is painted or vinyl coated in a color of choice. The sign is viewed from the non-reflective, painted or coated side of the mirrored light transmitting material. The thickness of the light transmitting sheet should be 0.118″ for signs up to 10″ tall by any length and 0.220 for signs up to 16″ tall by any length.

An image is created by engraving away the paint or vinyl and silver mirror coating on the front side of the sign only in the areas to be illuminated. The engraving must be of sufficient depth to remove all of the paint or vinyl and silver mirror coating in the chosen areas on the front of the sign, but should cut into the light transmitting material as little as possible. This is most effectively done by CNC router, but etching by hand may be used. Alternately, a non mirrored light transmitting sheet may be used in which an image is created by cutting out regions on a silver mirror backed sheet of mylar or vinyl which is then stuck to the front of the light transmitting sheet. Traditional sign vinyl cutting equipment may be used for this process. The vinyl must be mirrored silver on the back and may be any color desired on the front.

Latex or acrylic paint is then applied to the back side of the sign, but only in regions directly opposite the engraved or cut out regions on the front of the sign, and extending out from these regions by an amount approximately equal to the thickness of the sheet of light transmitting material. This paint or coating may be of any color, but bright colors or white are preferable, as this is the portion of the sign that will be illuminated. Exterior acrylic or latex paint is well suited for this purpose, as it bonds well to acrylic light transmitting sheet and reflects the most light out of the sheet toward the viewer.

The lighting system is comprised of surface mount light emitting diodes attached to a thin flexible circuit board ribbon (SMD LED strip) sealed in a transparent waterproof PVC tube. Bright white LED's are preferable, especially if the sign is to illuminate in multiple colors. The PVC tube containing the LED strip is housed inside a piece of light blocking trim attached to 2 or more edges of the light transmitting sheet. The trim is attached to the 2 longest sides of a rectangular sign board at a minimum. This trim may consist of any flexible plastic which will block any light from the light emitting diodes which does not shine into the light transmitting material. The trim piece must be secured to the light transmitting sheet with waterproof glue. The PVC tube containing the SMD LED strip is not secured to the light blocking trim to allow for replacement if needed by sliding it out the end of the trim. The ends of both the light blocking trim and the transparent tube should be sealed with silicone to prevent water intrusion.

The back side of the sign is covered with a piece of silver mirrored vinyl film or added protection against scratches, dirt, and deterioration. The vinyl must be such that the side facing the light transmitting sheet is silver mirrored. This is done after the painting of the illuminated areas on the back of the sign is complete and dry. There are no cutouts or engraved areas on the back side of the sign.

1. An edge lit sign consisting of a sheet of light transmitting material in which the front face has a silver mirror coating covered by paint, or vinyl film, such that the reflective side of the sheet faces away from the viewer and an image or text is created on the non reflective side of the sheet by engraving away portions of that mirror and paint coating, leaving only the light transmitting sheet and areas on the back of the sheet of light transmitting material directly opposite and extending slightly beyond the engraved regions on the front face are painted.

2. An edge lit sign consisting of a sheet of light transmitting material in which the front face of the sheet is covered by vinyl or mylar film which is silver mirrored on the back. The vinyl or mylar film has areas cut out of it so as to create an image or text and areas on the back of the sheet of light transmitting material directly opposite and extending slightly beyond the cutout regions of the vinyl or mylar are painted.

3. The sign of claim 1 or 2 in which the light transmitting sheet of is illuminated by light emitting diodes shining into the edge of the sheet.

4. The sign of claim 1 or 2 in which the back side of the light transmitting sheet is also covered with a silver mirrored vinyl or mylar film.

5. The sign of claim 1 or 2 in which the light transmitting sheet is illuminated by a strip consisting of SMD light emitting diodes attached to a ribbon circuit board and enclosed in light blocking trim attached to the edge of the sign.

6. The sign of claim 1 or 2 in which the light transmitting sheet is illuminated by a strip consisting of SMD light emitting diodes attached to a ribbon circuit board and enclosed in a waterproof transparent plastic tube which is enclosed in light blocking trim attached to the edge of the sign.

7. The sign of claim 1 or 2 in which a neodymium magnet and galvanized steel plate is attached to the back of the sign for mounting purposes.
